(19) United States
(12) Patent Application Publication
(10) Pub. No.: US 2022/0300853 A1
(43) Pub. Date: Sep. 22, 2022

(54) PRIVACY PRESERVING JOINT TRAINING OF MACHINE LEARNING MODELS

(71) Applicant: NEC Laboratories Europe GmbH, Heidelberg (DE)

(72) Inventors: Roberto Gonzalez Sanchez, Heidelberg (DE); Vittorio Prodomo, Leganes (ES); Marco Gramaglia, Leganes (ES)

(21) Appl. No.: 17/336,345

(22) Filed: Jun. 2, 2021

Related U.S. Application Data
(60) Provisional application No. 63/162,591, filed on Mar. 18, 2021.

(51) Int. Cl. G06N 20/00; G06K 9/62; G06F 21/62

(52) U.S. Cl. CPC G06N 20/00; G06K 9/6247; G06K 9/6256; G06F 21/6245

(57) ABSTRACT

Systems and method for training a shared machine learning (ML) model. A method includes generating, by a first entity, a data transformation function; sharing, by the first entity, the data transformation function with one or more second entities; creating a first private dataset, by the first entity, by applying the data transformation function to a first dataset of the first entity; receiving one or more second private datasets, by the first entity, from the one or more second entities, each second private dataset having been created by applying the data transformation function to a second dataset of the second entity; and training a machine learning (ML) model using the first private dataset and the one or more second private datasets to produce a trained ML model.

### CROSS-REFERENCES TO RELATED APPLICATIONS

The present application claims priority to U.S. Provisional Patent Application No. 63/162,591, filed Mar. 18, 2021, entitled “PRIVACY PRESERVING JOINT TRAINING OF MACHINE LEARNING MODELS,” which is hereby incorporated by reference in its entirety herein.

### FIELD

The present embodiments relate to artificial intelligence (AI), and in particular to a method, system and computer-readable medium for allowing different entities to jointly train a machine learning (ML) model in a privacy preserving manner

### BACKGROUND

The number of AI and ML-based applications that are used in production and real-world environments has increased greatly in recent years as a result of significant advances obtained in different areas. These applications range from the personalization of services or improved healthcare for patients to the automatic management of networks by telecommunications operators in the new 5G architectures. However, these applications pose different privacy and confidentiality issues since they rely on input data that originates from possibly heterogeneous sources (either human or other machines) and is spread through platforms owned by different entities that may not be fully trusted.

### SUMMARY

The present embodiments provide systems and method for jointly training a machine learning models while preserving data privacy for the participating entities. According to an embodiment, a method for training a shared machine learning (ML) model comprises the steps of generating, by a first entity, a data transformation function; sharing, by the first entity, the data transformation function with one or more second entities; creating a first private dataset, by the first entity, by applying the data transformation function to a first dataset of the first entity; receiving one or more second private datasets, from the one or more second entities, each second private dataset having been created by applying the data transformation function to a second dataset of the second entity; and training a machine learning (ML) model using the first private dataset and the one or more second private datasets to produce a trained ML model.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates schema of use of the system according to an embodiment of the present invention to jointly train and query an ML/AI model;

FIG. 2 schematically illustrates schema used to query the model according to an embodiment of the present invention;

FIG. 3 graphically illustrates results of a benchmark study demonstrating effectiveness of embodiments of the present invention in improving privacy of data; and

FIG. 4 schematically illustrates schema of a privacy preserving function (PPF) generator according to an embodiment of the present invention.

FIG. 5 is a block diagram of a processing system according to an embodiment.

### DETAILED DESCRIPTION

Embodiments of the present invention advantageously enable different entities to jointly train (and query) an ML (or AI) model while maintain privacy of each entities' private or confidential information used to train and/or query the ML model.

According to an embodiment, a method for training a shared machine learning (ML) model includes the steps of generating, by a first entity, a data transformation function; sharing, by the first entity, the data transformation function with one or more second entities; creating a first private dataset, by the first entity, by applying the data transformation function to a first dataset of the first entity; receiving one or more second private datasets, by the first entity, from the one or more second entities, each second private dataset having been created by applying the data transformation function to a second dataset of the second entity; and training a machine learning (ML) model using the first private dataset and the one or more second private datasets to produce a trained ML model.

According to an embodiment, the training is performed by the first entity.

According to an embodiment, when applied to a dataset, the data transformation function produces a private dataset including a numeric vector representation of raw data in the dataset, without any original values of the raw data in the dataset.

According to an embodiment, the step of generating a data transformation function includes training the data transformation function using data.

According to an embodiment, the data transformation function includes one of a principal component analysis (PCA) algorithm, an auto-encoder algorithm, a noise addition algorithm or a complex representation learning algorithm.

According to an embodiment, the method further includes querying the trained ML model using a private dataset, wherein the querying may include: creating a third private dataset, by the first entity or by one of the second entities, by applying the data transformation function to a third dataset of the first entity or the second entity; and querying the trained ML model using the third private dataset.

According to an embodiment, the method further includes receiving a result from the trained ML model in response to the querying.

According to an embodiment, the method further includes optimizing the data transformation function by inputting raw data of a dataset into an optimization system including: a privacy preserving generator configured to learn data representations of the raw data; a classifier configured to measure accuracy of a ML task; a reconstructor configured to recover the raw data; a discriminator configured to ensure the data representations are similar to facsimile data; and an attack simulator configured to ensure an external entity is unable to recover the raw data.

According to another embodiment, a system is provided that includes one or more processors which, alone or in combination, are configured to provide for execution of a method of training a shared machine learning (ML) model, the method comprising: generating, by a first entity, a data transformation function; sharing, by the first entity, the data transformation function with one or more second entities; creating a first private dataset, by the first entity, by applying the data transformation function to a first dataset of the first entity; receiving one or more second private datasets, by the first entity, from the one or more second entities, each second dataset having been created by applying the data transformation function to a second dataset of the second entity; and training a machine learning (ML) model using the first private dataset and the one or more second private datasets to produce a trained ML model.

According to another embodiment, a method of training a shared machine learning (ML) model is provided and includes generating, by a first entity, a data transformation function; sharing, by the first entity, the data transformation function with a second entity; creating a first private dataset, by the first entity, by applying the data transformation function to a first dataset of the first entity; creating a second private dataset, by the second entity, by applying the data transformation function to a second dataset of the second entity; and training a machine learning (ML) model using the first private dataset and the second private dataset to produce a trained ML model.

According to an embodiment, the training is performed by the first entity, and the second entity provides the second private dataset to the first entity.

According to an embodiment, the method further includes querying the trained ML model using a private dataset, wherein the querying may include: creating a third private dataset, by the first entity or by the second entity, by applying the data transformation function to a third dataset of the first entity or the second entity; and querying the trained ML model using the third private dataset.

According to an embodiment, the method further includes receiving a result from the trained ML model in response to the querying.

According to an embodiment, the method further includes optimizing the data transformation function by inputting raw data of a dataset into an optimization system including: a privacy preserving generator configured to learn data representations of the raw data; a classifier configured to measure accuracy of a ML task; a reconstructor configured to recover the raw data; a discriminator configured to ensure the data representations are similar to facsimile data; and an attack simulator configured to ensure an external entity is unable to recover the raw data.

According to another embodiment, a tangible, non-transitory computer-readable medium is provided that has instructions thereon which, upon being executed by one or more processors, alone or in combination, provide for execution of any of the methods of training a shared machine learning (ML) model as described herein.

In an embodiment, the present invention provides a method to allow different entities to jointly train (and query) an ML (or AI) model without the need of disclosing private or confidential information. A leader entity, in charge of training the model, generates a privacy preserving function (PPF) that is shared with the other entities. The PPF is created to generate a (vector) representation of data that is not human readable. Then, all the entities can apply the PPF to their data and (optionally) share the PPF generated representation of their data with the leader. Such PPF generated representations of data may be used to train a functional ML model without recovering the original data. The model generated can thereafter be used by the different entities feeding it with data generated by the PPF. As used herein, the term entities includes parties, partners, individual users, companies, factories, machines and devices (such as Internet of Things (IoT) devices).

The study of privacy implications for individuals has attracted the focus of different research communities in the past decades, resulting in different proposed solutions to allow data sharing while avoiding the identification of specific users. Such solutions include k—anonymity, l—diversity, and t—closeness. However, all these solutions are designed to keep the dataset in a human-readable format, without considering the implications of the modifications on downstream ML tasks. Other solutions, such as the differential privacy paradigm can ensure the privacy of ML tasks with strong theoretical guarantees, but these solutions are difficult to apply in practice, especially when sharing entire datasets is required to complete a task. Moreover, these solutions are created to avoid the identification of a single user, but they may not apply when the data is generated by machines, for example. As an example, if different factories want to share data of their sensors to jointly train a predictive maintenance model, the aforementioned solutions would disclose the dataset as it is (since most sensor reads are similar or equal), thereby disclosing the original data values, which may include business confidential data. Other solutions such as homomorphic encryption allow the application of certain functions over the data without disclosing the original information and without affecting the accuracy of the operation. However, these solutions impose heavy computational loads and thereby require significantly more computational resources and power.

Different solutions to collaboratively train ML models without sharing data, such as Federated learning, have also appeared in recent years. However, it has been demonstrated that attacks are still possible, the ability to discover the training data is possible with respect to those solutions (see De Cristofaro, Emiliano, “An Overview of Privacy in Machine Learning,” arXiv2005.08679 (Mar. 18, 2020), which is hereby incorporated by reference herein). Moreover, these solutions are in general technically very complex and require all the entities involved to be trusted.

Accordingly, there are a number of technical challenges to address in designing a system that allows entities such as companies (and individuals) to share data in a confidential/private way.

In an embodiment, the present invention provides a system designed to train an ML (or AI) model using data from different entities, without the need for sharing the raw data and without active collaboration between the different entities in the training process. To this end, a leader entity (hereinafter “leader”) is in charge of starting the process. The leader may be any entity or a designated entity. The leader creates a PPF and shares the PPF with the other entities. Then, all the entities use the PPF to generate privacy preserving representations of their data that can be made public. The leader then uses all the data to train a ML (or AI) model. Finally, data from any or all of the entities can be used to feed the model.

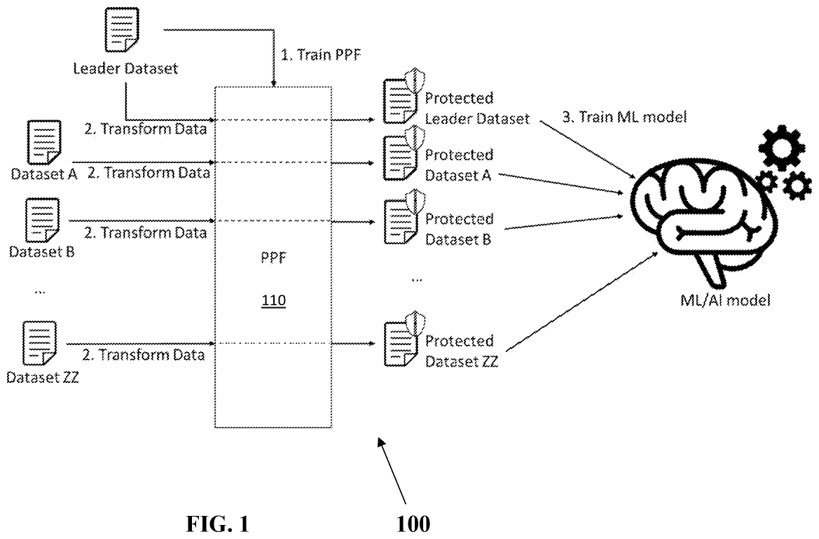

FIG. 1 schematically illustrates a method and global design of a system 100 for providing training data and training an ML/AI model according to an embodiment. In an embodiment, the method includes, at step 1, generating a PPF 110 and training the PPF 110. For example, in an embodiment, a leader creates a PPF.

For example, generating a PPF 110 may include creating a PPF 110 and training the PPF 110 with data. A PPF may include algorithms commonly used to reduce the dimensionality of the data such as principal component analysis (PCA) or auto-encoders or other algorithms, and training the PPF 110 may include applying the PPF to training data (real or fabricated data). For example, the leader may us its own knowledge (usually data, but the leader could also generate the PPF 110 without data) to create and train the PPF 110. Once created, the leader provides or distributes the PPF 110 to each entity to be involved in the ML/AI training and/or query process. In some instances, training may not be necessary, depending on the PPF in use. For example, the PPF can be outside the deep learning domain (in which case training is not needed) or the PPF can have a specific way of training that depends on the selected architecture. In any case, the PPF can be trained on real data or fabricated data which may have some statistical property that make it comparable to real data (e.g., min-max values, average value, etc.).

In an embodiment, at step 2, the involved entities (including the leader) use the PPF to generate a privacy preserving version of their datasets (e.g., “Dataset A,” “Dataset B,” “Dataset ZZ” for entities A, B ZZ and “Leader Dataset” for the leader entity). For example, each involved entity may apply the PPF to the dataset to transform the dataset into a privacy preserving version of the dataset (“protected dataset”). At step 3, in an embodiment, one or more of these privacy preserving versions of the datasets (“protected datasets”) may be used as input to train an ML/AI model. For example, one or more of the “Protected Leader Dataset,” “Protected Dataset A,” “Protected Dataset B,” . . . “Protected Dataset ZZ” may be used to train the ML/AI model. Hence, each protected dataset may be used as an input training data source. Additional attributes, parameters, prediction targets, etc. may be provided as needed to control the particular ML/AI model being trained.

In a subsequent phase, new data of the leader or the other involved entities can be used to query the trained ML/AI model. Preferably, the data passes through the PPF 110 before it is used to query the model to ensure privacy, but it need not if a particular involved entity does not require privacy. One or more or all of the protected datasets, e.g., protected Dataset A . . . Dataset ZZ, may be sent back to the leader so that the leader may perform training and/or querying using the received protected dataset(s). Additionally, or alternately, one or more of the involved entities may perform training and/or querying.

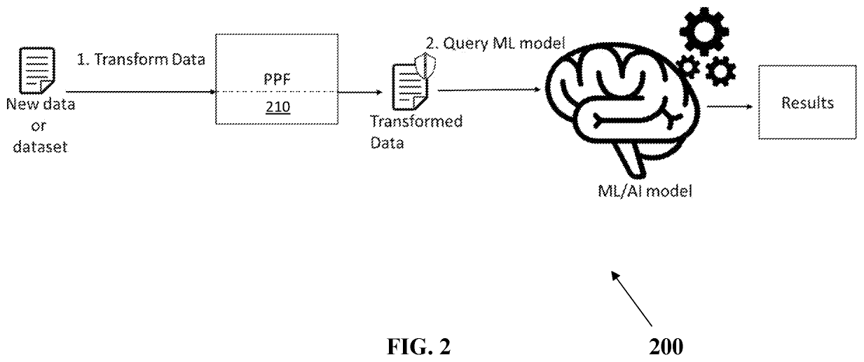

FIG. 2 schematically illustrates a process flow 200 (method and system elements shown) for querying the trained model in order to obtain results. In an embodiment, the method includes, at step 201, passing the data to be used to query the model through the PPF 210 to obtain the transformed/protected data; and at step 202, feeding the transformed data to the ML/AI model, which returns a result or results. For example, the results obtained can be part of a regression or classification for the data to be checked.

The PPF 210, which is an important component for improving the data privacy according to embodiments of the present invention, may include an algorithm that, given a dataset composed by a set of elements (e.g., tuples, images, sound, nodes of a graph, etc.), transforms the dataset into a vector representation that does not include private data. The PPF 210 performs the transformation in a way that creates extreme technical difficulties to recover the original data from the data representation. The PPF 210 may be configured to either transform all the raw data or transform only the parts of the data that include private/confidential information. Furthermore, the PPF 210 is configured in a way in which the transformed/protected data output can be used to train the downstream ML/AI model. For example, the PPF 210 advantageously removes the human readability of the data to increase data security and privacy, while at the same time maintaining the utility of the data for the ML/AI training and associated tasks.

Examples of a PPF (110, 210) include algorithms commonly used to reduce the dimensionality of the data such as principal component analysis (PCA) or autoencoders, privacy preserving transformation such as noise addition (see Zhang, Tianwei, et al., “Privacy-preserving Machine Learning through Data Obfuscation,” arXiv:1807.01860 (Jul. 13, 2018), which is hereby incorporated by reference herein), complex representation learning algorithms such as embedding propagation (EP) (see Garcia-Duran, Alberto, et al., “Learning Graph Representations with Embedding Propagation,” Advances in Neural Information Processing Systems, Vol. 30, pp. 5119-5130 (Oct. 9, 2017), which is hereby incorporated by reference herein), or algorithms specially tailored for the task (including neural networks). Embodiments of the present invention are not limited to these specific algorithms, and include the use of adapted or modified versions of these algorithms, as well as other data processing algorithms.

The leader is the entity or one of the entities that is in charge of the generation of the PPF. To this end, the leader can use data it owns or generate the PPF based on previously generated PPFs. As an example, the leader can train a PCA transformation matrix for its own data. After the PPF is generated, the leader distributes it to the other entities.

Generating private datasets: All the participants in the process (i.e., involved entities and leader entity(ies)) use the PPF to create private representations of their own raw data. This data could be personal data, sensor data, medical data or any other kind of private, confidential or sensitive data. In any case, after the PPF is applied, a numeric vector representation will be created and will not include any of the original values.

Demonstration of feasibility of the PPF: Embodiments of the present invention provide for the ability to determine and use a PPF that is able to generate a protected version of the data without removing all the information included within the data. In the following, an evaluation of different state of the art algorithms is presented along with a study of trade-off of accuracy versus privacy when using these algorithms. These algorithms are traditionally used either to improve the accuracy of ML processes (e.g., PCA), to detect anomalies (e.g., autoencoders) or to hide specific information from the data (e.g., a noise addition transformation).

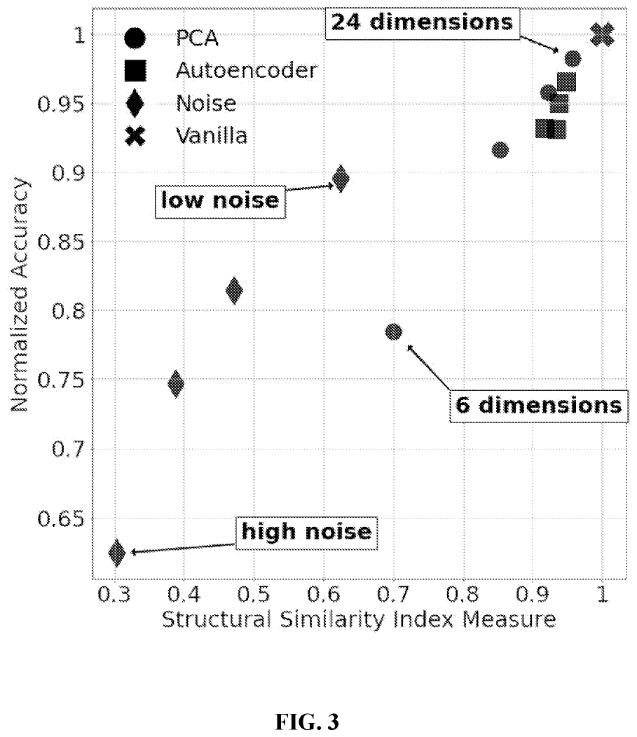

FIG. 3 graphically shows results from an initial benchmark study on the effectiveness of the PPF using different state of the art algorithms. In particular, PCA, an autoencoder and a random noise adder were used as the PPFs. The reconstructed data, which is an obfuscated version of the original data, is then used to train an ML model on a simple classification task. The accuracy loss was determined with respect to the accuracy of a model trained with the raw data to provide a measure of the utility retained by the data after the transformation. At the same time, the similarity between the reconstructed data and the original data was measured with a few metrics. In the specific plot of FIG. 3, the Structural Similarity Measure Index (SSIM) is used, which ranges from 0 (very dissimilar) to 1 (equal). Vanilla refers to the accuracy/similarity obtained with raw data, that has not been processed using a PPF.

As can be seen in FIG. 3, the more information that is lost, the more the similarity decreases, and the accuracy of the ML model drops significantly, too. Novel PPFs can be created to improve the utility-accuracy tradeoff. The dimensions shown in FIG. 3 are the dimension retained by the PCA algorithm by retaining more dimension, the data can be used to obtain higher accuracy but it also has more similarity (hence less privacy).

Shared information and communication technologies (ICT) infrastructure performance and cybersecurity

The popularity of shared ICT infrastructure has increased dramatically over the past years, from the traditional renting of resources in cloud providers for web services to full virtual deployments of complex ICT systems such as the virtual deployment of the Rakuten network. In this scenario, the operator of the ICT infrastructure (in charge of optimizing the performance) does not have visibility over the real experience and operation of the services running. This makes it impossible to forecast the resources required, and makes it very difficult to apply statistical multiplexing techniques.

Utilizing embodiments of the present invention, however, the infrastructure manager could learn the behavior of the different services without the need of sharing any possibly confidential or private information. The different services using the infrastructure may run a tailored PPF that encodes different values such as memory utilization per process, number of concurrent connections and service nature (e.g., if the connection is serving a live streaming video or mail service). The data encoded by the PPF could be used by the infrastructure owner to train/query an ML/AI model to forecast the resources required for different services, adapting that way the resources to the demand.

Moreover, a PPF could be specifically tailored to encode information related to the connections of the different services to detect possible cyberattacks. Information such as the interne protocol (IP) address starting the connection, the number of connections per service or the connection duration can be used to detect attacks ranging from Distributed Denial of Service Attacks (DDOS) to unauthorized access to data.

### Remote Predictive Maintenance

With the advent of the Industry 4.0 paradigm, factories are nowadays heavily connected and monitored by hundreds or even thousands of sensors. This allows factory owners to better control the processes and to predict the failure of different components. However, the training of the ML models for such applications is typically done in isolation from other factories that may be using the exact same component/equipment previously manufactured by a third party company. This increases the complexity of creating efficient ML models, as each company usually has to build from scratch. This scenario is not limited to factories, but also occurs in a wide range of technological areas (e.g., manufacturers of components for wind-power generators do not have visibility over the components performance after they are set up by the power generation company, and vehicle manufacturers typically do not have access to the vehicle telemetry data in operation). This isolation is in part because of privacy/confidentiality concerns by the different entities. Companies tend to avoid information sharing about internal processes with other companies to keep their competitive advantages. However, it would be in the best interests of all entities to allow for sharing for different purposes, such as to provide for improving the forecast of possible failures, if it could be done in a safe manner.

According to an embodiment of the present invention, a manufacturer may create and send a PPF together with the component/equipment to its customers or integrate the PPF together with the component/equipment (e.g., a vehicle manufacturer can include the PPF in the vehicle system). Then, during normal operation, the values obtained from the different sensors related to the component (e.g., temperature, pressure, speed, etc.) can be transformed using the PPF and sent back to the manufacturer. The transformed data can be used, first, to train an ML/AI model for predictive maintenance and, next, to query the model and efficiently detect problems before the production is affected.

### Optimized PPF Generator

Embodiments of the present invention advantageously provide to generate a PPF specific for the optimization of the privacy versus accuracy trade-off discussed above with respect to FIG. 3. According to an embodiment, the PPF generator is a compound system which adapts the concept of adversarial attack to the problem. The compound system is composed of different neural network modules, each of them with a specific role.

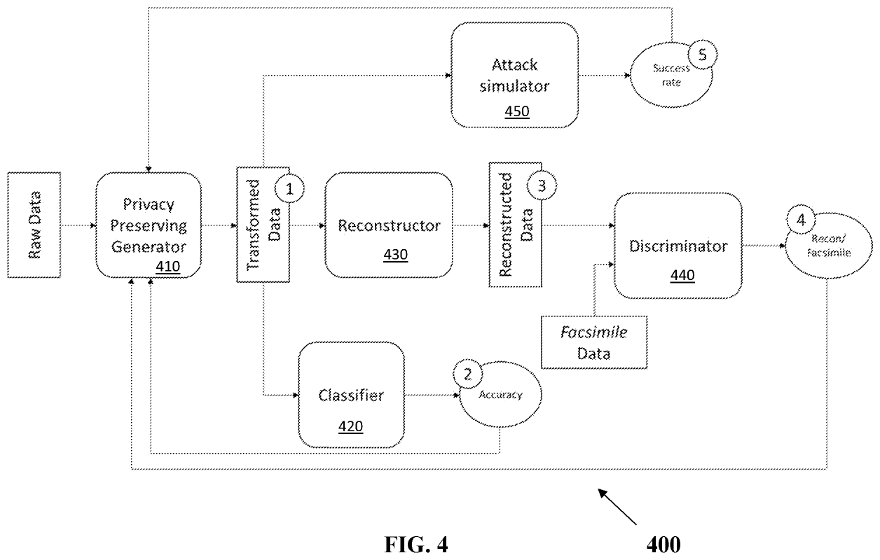

FIG. 4 illustrates a privacy preserving function (PPF) optimization system 400 according to an embodiment. Referring to FIG. 4, a privacy preserving function (PPF) generator component 410 takes the raw data 406 and applies a transformation also guided by various, different feedback signals coming from the other modules or components of the system, to produce and output transformed data 401. Transformed data 401 is a representation of the original data 406 in a latent space. Moreover, the final model obtained will be used as the PPF. The transformed data 401 is fed into two models: the classifier component 420 and the reconstructor component 430. The classifier 420 performs the ML task that the overall system needs to perform. This, as discussed above, can be shared across the different involved entities without any problem as it does not contain sensitive data. The accuracy 402 (i.e., an accuracy measure) of the classifier 420 may be maximized to guarantee the good performance of the system. This is achieved, in an embodiment, by feeding this information into the privacy preserving generator 410. With respect to the reconstructor 430, the overall objective of the system is to counter specific attacks on the data, which may involve the reconstruction to the original format. For this, the reconstructor 430 performs a decoding of the transformed data 401 bringing the data again to the original format as reconstructed data 403. This allows a better understanding of the kind of attacks that may be posed to the data as they use the full information.

The discriminator component 440 provides the second feedback loop to the privacy preserving generator 410. A goal of the discriminator 440 is to discriminate between the samples generated by the reconstructor 430 and the ones set as a reference for the “privacy preserving data” to determine reconstructions and facsimiles 404. These samples should have similar statistical properties with respect to the original data 406 but be completely synthetic and sampled from a random distribution. Depending on the type of data, same mean or median may be enforced or, in a case where the mean is a sensitive attribute, scaled versions or standard deviation to mean ratios may be used. The feedback coming from the discriminator 440 is used by the privacy preserving generator 410 to steer the generation towards this kind of data, as the objective of the chain of the generator 410, the reconstructor 430 and the discriminator 440 is to provide samples close to the facsimile ones.

The attack simulator 450 of the system mimics an attacker. The attack simulator component 450 provides further precision on the generation of the transformed data 401, as the kind of posed attacks may be unknown a priori by the tenant and thus could be run by another entity, which could be a tenant, but it can also be a third party attacker in case the data is leaked from the platform in an unwanted way . This further feedback provides a success rate 405 (e.g., success rate value or measure) for feedback and acts as an adjustment mechanism for the tenant generating the privacy preserving data on the achieved privacy and accuracy trade-off.

The privacy preserving generator 410 is a core component of the system and may be implemented in different ways. For example, the privacy preserving generator 410 can be implemented to apply a dimensionality reduction with a variable number of retained dimensions, which can be customized using the feedback provided by the other modules (e.g., decrease or increase depending on the output of the attacker and classifier modules, respectively). As another example, a neural network-based encoder could be used for implementing the privacy preserving generator 410. In this case, the feedback is mixed in the loss function of this module.

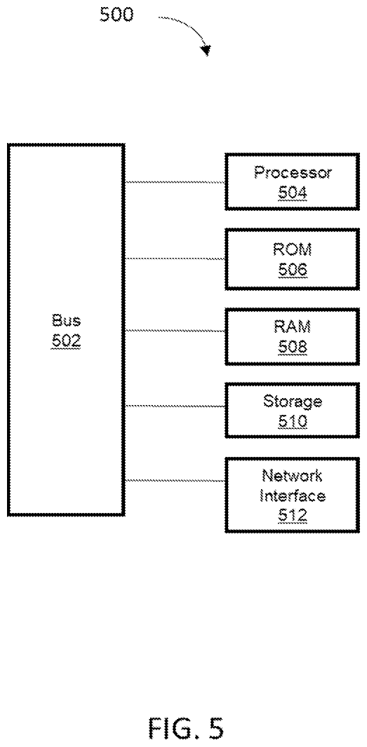

FIG. 5 is a block diagram of a processing system 500 according to an embodiment. The processing system 500 can be used to implement the protocols, devices, entities, mechanisms, systems and methods described above and herein. For example, each entity (e.g., leader entity, and entities A-ZZ) may include a processing system 500, and the ML/AI model may be instantiated on, and the ML/AI training and query processes may be implemented using, a processing system 500. Additionally, a privacy preserving generator system 400, and/or individual components of system 400, may be implemented by a processing system 500. A processing system 500 may include one or multiple processors 504 (only one shown), such as a central processing unit (CPU) of a computing device or a distributed processor system. The processor(s) 504 executes processor-executable instructions for performing the functions and methods described above. In embodiments, the processor executable instructions are locally stored or remotely stored and accessed from a non-transitory computer readable medium, such as storage 510, which may be a hard drive, cloud storage, flash drive, etc. Read Only Memory (ROM) 506 includes processor-executable instructions for initializing the processor(s) 504, while the random-access memory (RAM) 508 is the main memory for loading and processing instructions executed by the processor(s) 504. The network interface 512 may connect to a wired network or cellular network and to a local area network or wide area network, such as the Internet, and may be used to receive and/or transmit data, including datasets such as instantiation requests or instructions, analytics task(s), datasets representing requested data or data streams acting as input data or output data, etc. In certain embodiments, multiple processors perform the functions of processor(s) 504.

The prior lack of effective solutions has delayed the application of AI in completely different fields ranging from manufacturing to digital health. In the following, a non-comprehensive list of possible applications and use cases for the present embodiments is provided.

Cybersecurity: In this application, cloud providers cannot inspect the encrypted traffic flowing to/from their hosted services. Moreover, these hosted services typically cannot or do not want to give access to the full trace to the cloud infrastructure provider, that sometimes may even provide competing services (e.g., SPOTIFY is hosted in GOOGLE Cloud, but GOOGLE is also running YOUTUBE Music that is a direct competitor). However, the hosted service would be interested to collaborate with the cloud provider to obtain better performance and security.

Manufacturing: Component providers for factories limit the analysis of the component behavior to internal tests. However, they lose visibility over their operation and performance when the component is actually used in the factories. With the current trend towards Industry 4.0, factories are full of sensors and IoT devices, but they don't share this data with the providers since it may include confidential information. However, such sharing of data would be of interest for both sides in order to obtain improved performance.

Customer electronics: Similar to the previous case, manufacturers typically lose track of the performance of the goods they sell (from home appliances to cars). In this case, sharing data of the user may have serious privacy implications.

Digital health: Different hospitals may want to share data of patients to improve the ML models they create. Again, this will bring privacy implications. Moreover, other health-related companies such as those developing health monitors (e.g., FITBIT) could also share the data with third parties if they could efficiently anonymize it.

Embodiments of the present invention provide for the following advantages:
1. One entity selects a “data transformation function” (e.g., a PPF) and shares it with other collaborative entities. Then, all the collaborative entities use the “data transformation function” to transform their own dataset. The transformed datasets are then used both for training and/or querying a standard ML model (or specialized ML model) without requiring any modification to the ML model.
2. A PPF generator composed of five main blocks interacting in three feedback loops is provided: The privacy preserving generator learns data representations, the classifier measures the accuracy of the ML task, the reconstructor recovers the original raw format, the discriminator ensures the representations are similar to some average/facsimile data and the attack simulator ensures an external attacker cannot recover the raw data.
3. Compared to traditional ML/data sharing, embodiments of the present invention improve privacy by creating data that is not similar to the original data.
4. Compared to homomorphic encryption, embodiments of the present invention are much simpler and efficient since encryption/decryption is not required in every operation.
5. Compared with federated learning, embodiments of the present invention do not require different parties training together a model in an online fashion. Instead, embodiments of the present invention allow the generation of privacy preserving datasets that can be seamlessly shared and used to train different models.

In an embodiment, the present invention provides a method for training a shared ML model, the method comprising the steps of:
1. One of the entities (the leader) generates a PPF and shares it with the other entities.
2. All the entities create private representations of their datasets and share it with the leader.
3. The leader or another entity uses some or all the transformed data to train an ML model.

In another embodiment, the present invention provides a method for using a shared ML model, the method comprising the steps of:
1. The PPF function is used to transform the query data.
2. The leader or another entity uses the ML model (or shares it with the other entities) querying it with transformed data.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the present invention. In particular, the present invention covers further embodiments with any combination of features from different embodiments described herein. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of training a shared machine learning (ML) model, the method comprising the steps of:
generating, by a first entity, a data transformation function;
sharing, by the first entity, the data transformation function with one or more second entities;
creating a first private dataset, by the first entity, by applying the data transformation function to a first dataset of the first entity;
receiving one or more second private datasets, by the first entity, from the one or more second entities, each second private dataset having been created by applying the data transformation function to a second dataset of the second entity; and
training a machine learning (ML) model using the first private dataset and the one or more second private datasets to produce a trained ML model.

2. The method of claim 1, wherein the training is performed by the first entity.

3. The method of claim 1, wherein when applied to a dataset, the data transformation function produces a private dataset including a numeric vector representation of raw data in the dataset, without any original values of the raw data in the dataset.

4. The method of claim 1, wherein the step of generating a data transformation function includes training the data transformation function using data.

5. The method of claim 1, wherein the data transformation function includes one of a principal component analysis (PCA) algorithm, an auto-encoder algorithm, a noise addition algorithm or a complex representation learning algorithm.

6. The method of claim 1, further including querying the trained ML model using a private dataset.

7. The method of claim 6, wherein the querying includes:
creating a third private dataset, by the first entity or by one of the second entities, by applying the data transformation function to a third dataset of the first entity or the second entity; and
querying the trained ML model using the third private dataset.

8. The method of claim 6, further including receiving a result from the trained ML model in response to the querying.

9. The method of claim 1, further including:
optimizing the data transformation function by inputting raw data of a dataset into an optimization system including:
a privacy preserving generator configured to learn data representations of the raw data;
a classifier configured to measure accuracy of a ML task;
a reconstructor configured to recover the raw data;
a discriminator configured to ensure the data representations are similar to facsimile data; and
an attack simulator configured to ensure an external entity is unable to recover the raw data.

10. A system comprising one or more processors which, alone or in combination, are configured to provide for execution of a method of training a shared machine learning (ML) model, the method comprising:
generating, by a first entity, a data transformation function;
sharing, by the first entity, the data transformation function with one or more second entities;
creating a first private dataset, by the first entity, by applying the data transformation function to a first dataset of the first entity;
receiving one or more second private datasets, by the first entity, from the one or more second entities, each second dataset having been created by applying the data transformation function to a second dataset of the second entity; and
training a machine learning (ML) model using the first private dataset and the one or more second private datasets to produce a trained ML model.

11. The system of claim 10, wherein when applied to a dataset, the data transformation function produces a private dataset including a numeric vector representation of raw data in the dataset, without any original values of the raw data in the dataset.

12. The system of claim 10, wherein the data transformation function includes one of a principal component analysis (PCA) algorithm, an auto-encoder algorithm, a noise addition algorithm or a complex representation learning algorithm.

13. The system of claim 10, wherein the method further includes:
creating a third private dataset, by the first entity or by one of the second entities, by applying the data transformation function to a third dataset of the first entity or the second entity; and
querying the trained ML model using the third private dataset.

14. The system of claim 10, wherein the method further includes optimizing the data transformation function by inputting raw data of a dataset into an optimization system, wherein the optimization system includes:
a privacy preserving generator configured to learn data representations of the raw data;
a classifier configured to measure accuracy of a ML task;
a reconstructor configured to recover the raw data;
a discriminator configured to ensure the data representations are similar to facsimile data; and
an attack simulator configured to ensure an external entity is unable to recover the raw data.

15. A tangible, non-transitory computer-readable medium having instructions thereon which, upon being executed by one or more processors, alone or in combination, provide for execution of a method of training a shared machine learning (ML) model, the method comprising:
generating, by a first entity, a data transformation function;
sharing, by the first entity, the data transformation function with one or more second entities;
creating a first private dataset, by the first entity, by applying the data transformation function to a first dataset of the first entity;
receiving one or more second private datasets, by the first entity, from the one or more second entities, each second dataset having been created by applying the data transformation function to a second dataset of the second entity; and
training a machine learning (ML) model using the first private dataset and the second private dataset to produce a trained ML model.
